(19) United States
(12) Patent Application Publication
(10) Pub. No.: US 2010/0138910 A1
(43) Pub. Date: Jun. 3, 2010

(54) METHODS FOR ENCRYPTED-TRAFFIC URL FILTERING USING ADDRESS-MAPPING INTERCEPTION

(75) Inventors: Ori Aldor, Tel Aviv (IL); Guy Guzner, Tel Aviv (IL); Izhar Shoshani-Levi, Kfar Saba (IL); Eytan Segal, Kadima (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: CHECK POINT SOFTWARE TECHNOLOGIES, LTD., Tel Aiv (IL)

(21) Appl. No.: 12/326,914

(22) Filed: Dec. 3, 2008

(51) Int. Cl. H04L 9/32

(52) U.S. Cl. 726/14

(57) ABSTRACT

The present invention discloses methods, media, and perimeter gateways for encrypted-traffic URL filtering using address-mapping interception, methods including the steps of: providing a client system having a client application for accessing websites from web servers; upon the client application attempting to access an encrypted website, performing a name-to-address query to resolve a name of the encrypted website; intercepting address-mapping responses; creating a mapping between the name and at least one network address of the encrypted website; intercepting incoming encrypted traffic; extracting a server's network address from the incoming encrypted traffic; establishing a resolved name being accessed using the mapping; and filtering the resolved name. Preferably, the step of filtering includes redirecting the encrypted traffic. Preferably, the method further includes the step of: blocking all encrypted traffic for unresolved names.

### FIELD AND BACKGROUND OF THE INVENTION

The present invention relates to methods for encrypted-traffic (e.g. HTTPS (Hyper-Text Transfer Protocol Secure)) URL (Uniform Resource Locator) filtering using address-mapping (e.g. DNS (Domain Name System)) interception.

In recent years, security has become an increasing concern in information systems. This issue has become more significant with the advent of the Internet and the ubiquitous use of network environments (e.g. LAN and WAN). SSL (Secure Sockets Layer) encrypted traffic has become a popular channel for malicious users to circumvent traditional detection methods for spreading malware by infiltrating networks through encrypted tunnels.

URL filtering is the process of allowing and disallowing access to Web sites (named by URLs), according to an organization's security policy. During the last couple of years, there has been a rise in the number of websites that offer an SSL interface to allow their users to avoid URL filtering and IP-based (Internet Protocol) filtering. The majority of such websites are “anonymizers” (i.e. websites with an SSL front that serve as a relay to any other website on the Internet). SSL usage creates a challenge for URL-filtering vendors that use IP-based filtering. Such approaches are problematic due to the inaccurate nature of “reverse-DNS lookup” that is employed.

In the prior art, Websense Inc., San Diego, Calif., provides a Websense Web Security Gateway backed by a Websense ThreatSeeker Network. The Websense approach provides a full SSL proxy with integrated certificate management. The Websense solution is based on actively terminating the SSL connection, and “impersonating” the actual server. However, such an approach creates a problematic user experience, since SSL was designed to alert the user about such techniques. Such an approach also poses connectivity issues.

Finjan Inc., San Jose, Calif., provides a Secure Web Gateway which enables integrated SSL inspection as part of an active, real-time web-security solution. The Secure Web Gateway decrypts incoming and outgoing SSL data at the gateway, analyzes the code using active real-time content inspection, and then re-encrypts the code.

Blue Coat Systems Inc., Sunnyvale, Calif., provides an SSL ProxySG platform which can deny threats from secured “phishing” attempts that now utilize SSL explicitly as a cloaking mechanism without degrading network performance. Cyberoam Inc., Woburn, Mass., supports content filtering of SSL traffic using domain names extracted from the certificates exchanged during SSL negotiation.

US Patent Publication No. 20070180510 by Long et al. (hereinafter referred to as Long '510) discloses methods and systems for obtaining URL filtering information using domain names extracted from an SSL certificate. US Patent Publication No. 20050050316 by Peles (hereinafter referred to as Peles '316) discloses passive decryption of SSL traffic using a shared private key to enable content filtering. US Patent Publication No. 20060248575 by Levow et al. (hereinafter referred to as Levow '575) discloses divided encryption connections to provide network traffic security using a similar approach as Peles '316.

It would be desirable to have methods for encrypted-traffic URL filtering using address-mapping interception, inter alia, avoiding the need for inspection of SSL traffic and overcoming the limitations of the prior art as described above.

### SUMMARY OF THE INVENTION

It is the purpose of the present invention to provide methods for encrypted-traffic URL filtering using address-mapping interception.

Preferred embodiments of the present invention employ URL filtering to protect and prevent web users from accessing websites that are forbidden by various authorization policies. In preferred embodiments, methods utilize the categorization of websites into well-known categories which in turn are used to define which sites are allowed and which sites are blocked. Typically, such a method would be used to prevent access to inappropriate websites (e.g. pornographic, job search, and arms-related sites) in a business setting. URL filtering provides a solid solution for non-encrypted traffic; however, encrypted traffic, which can also be used for legitimate purposes (e.g. mainly privacy), requires different handling to apply URL filtering.

Therefore, according to the present invention, there is provided for the first time a method for encrypted-traffic URL filtering using address-mapping interception, the method including the steps of: (a) providing a client system having a client application for accessing websites from web servers; (b) upon the client application attempting to access an encrypted website, performing, by the client application, a name-to-address query to resolve a name of the encrypted website; (c) intercepting, by a perimeter gateway, address-mapping responses; (d) creating, by the perimeter gateway, a mapping between the name and at least one network address of the encrypted website; (e) intercepting, by the perimeter gateway, incoming encrypted traffic; (f) extracting, by the perimeter gateway, a server's network address from the incoming encrypted traffic; (g) establishing, by the perimeter gateway, a resolved name being accessed using the mapping; and (h) filtering, by the perimeter gateway, the resolved name.

Preferably, the client application is a browser application.

Preferably, the name-to-address query is a DNS query, wherein the address-mapping responses are DNS responses, wherein the name is a domain name, wherein at least one network address is at least one IP-address, and wherein the resolved name is a resolved domain name.

Preferably, the incoming encrypted traffic includes at least one traffic type from the group consisting of: SSL-encrypted traffic, internet-Protocol-security (IPsec) traffic, secure-shell (SSH) traffic, transport-layer-security (TLS) traffic, and SSL-encrypted HTTP traffic.

Preferably, the step of filtering includes redirecting the encrypted traffic.

Preferably, the method further includes the step of: (i) blocking, by the perimeter gateway, all encrypted traffic for unresolved names.

Preferably, the method further includes the step of: (i) alerting a user or a system administrator about the encrypted traffic.

According to the present invention, there is provided for the first time a computer-readable storage medium having computer-readable code embodied on the computer-readable storage medium, the computer-readable code including: (a) program code for providing a client system with a client application for accessing websites from web servers; (b) program code for, upon the client application attempting to access an encrypted website, performing, by the client application, a name-to-address query to resolve a name of the encrypted website; (c) program code for intercepting, by a perimeter gateway, address-mapping responses; (d) program code for creating, by the perimeter gateway, a mapping between the name and at least one network address of the encrypted website; (e) program code for intercepting, by the perimeter gateway, incoming encrypted traffic; (f) program code for extracting, by the perimeter gateway, a server's network address from the incoming encrypted traffic; (g) program code for estabishing, by the perimeter gateway, a resolved name being accessed using the mapping; and (h) program code for filtering, by the perimeter gateway, the resolved name.

Preferably, the client application is a browser application.

Preferably, the name-to-address query is a DNS query, wherein the address-mapping responses are DNS responses, wherein the name is a domain name, wherein at least one network address is at least one IP-address, and wherein the resolved name is a resolved domain name.

Preferably, the incoming encrypted traffic includes at least one traffic type from the group consisting of: SSL-encrypted traffic, Internet-Protocol-security (IPsec) traffic, secure-shell (SSH) traffic, transport-layer-security (TLS) traffic, and SSL-encrypted HTTP traffic.

Preferably, the program code for filtering includes program code for redirecting the encrypted traffic.

Preferably, the computer-readable code further includes: (i) program code for blocking, by the perimeter gateway, all encrypted traffic for unresolved names.

Preferably, the computer-readable code further includes: (i) program code for alerting a user or a system administrator about the encrypted traffic.

According to the present invention, there is provided for the first time a perimeter gateway for encrypted-traffic URL filtering using address-mapping interception, the gateway including: (a) a query module for performing, upon a client application of a client system attempting to access an encrypted website, a name-to-address query to resolve a name of an encrypted website on a web server; (b) a response module for intercepting address-mapping responses; (c) a mapping module for creating a mapping between the name and at least one network address of the encrypted website; (d) an encrypted-traffic module for intercepting incoming encrypted traffic; (e) an extraction module for extracting a server's network address from the incoming encrypted traffic; (f) a resolving module for establishing a resolved name being accessed using the mapping; and (g) a filtering module for filtering the resolved name.

Preferably, the client application is a browser application.

Preferably, the name-to-address query is a DNS query, wherein the address-mapping responses are DNS responses, wherein the name is a domain name, wherein at least one network address is a at least one IP-address, and wherein the resolved name is a resolved domain name.

Preferably, the incoming encrypted traffic includes at least one traffic type from the group consisting of: SSL-encrypted traffic, Internet-Protocol-security (IPsec) traffic, secure-shell (SSH) traffic, transport-layer-security (TLS) traffic, and SSL-encrypted HTTP traffic.

Preferably, the filtering module is configured for redirecting the encrypted traffic.

Preferably, the gateway further includes: (h) a blocking module for blocking all encrypted traffic for unresolved names.

Preferably, the gateway further includes: (h) an alerting module for alerting a user or a system administrator about the encrypted traffic.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1 is a simplified schematic block diagram of a system for encrypted-traffic URL filtering using address-mapping interception, according to preferred embodiments of the present invention;

FIG. 2 is a simplified flowchart of the major operational steps for encrypted-traffic URL filtering using address-mapping interception during the mapping phase, according to preferred embodiments of the present invention;

FIG. 3 is a simplified flowchart of the major operational steps for encrypted-traffic URL filtering using address-mapping interception during the policy-enforcement phase, according to preferred embodiments of the present invention.

### DESCRIPTION OF THE PREFERRED EMBODIMENTS

The present invention relates to methods for encrypted-traffic URL filtering using address-mapping interception. The principles and operation for methods for encrypted-traffic URL filtering using address-mapping interception, according to the present invention, may be better understood with reference to the accompanying description and the drawings.

Encrypted websites use a certificate with a domain name; legitimate websites do not use an IP address as a valid domain name since IP addresses can change or be shared with other websites.

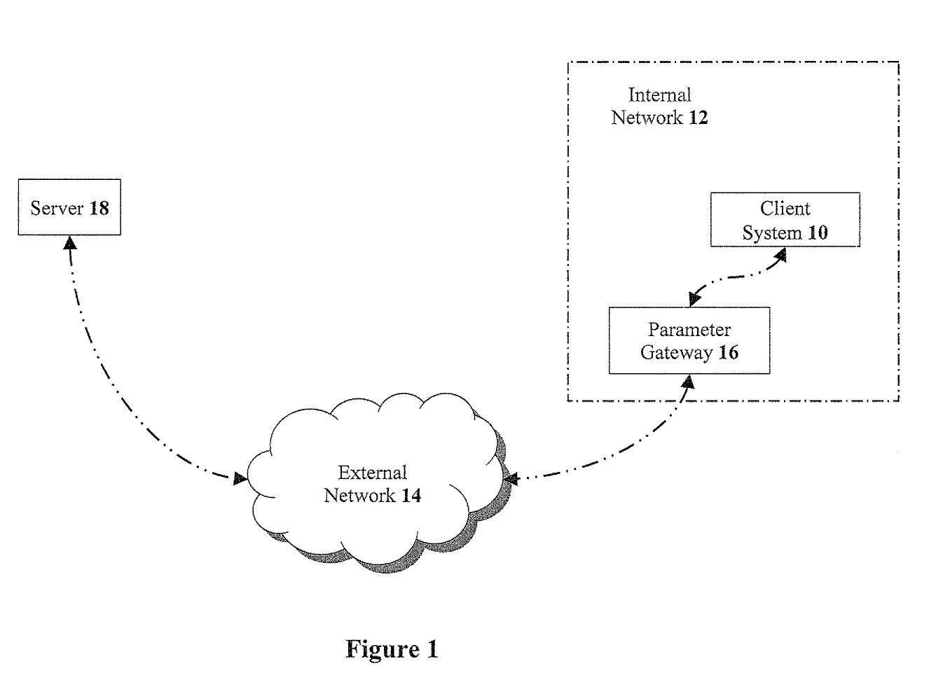

Referring now to the drawing, FIG. 1 is a simplified schematic block diagram of a system for encrypted-traffic URL filtering using address-mapping interception, according to preferred embodiments of the present invention. A client system 10, located in an internal network 12 (e.g. LAN), is operationally connected to an external network 14 (e.g. the Internet), via a perimeter gateway 16 protecting client system 10 from external network 14, and enforcing a security policy on client system 10. Client system 10 then can access a server 18 (e.g. a DNS web server).

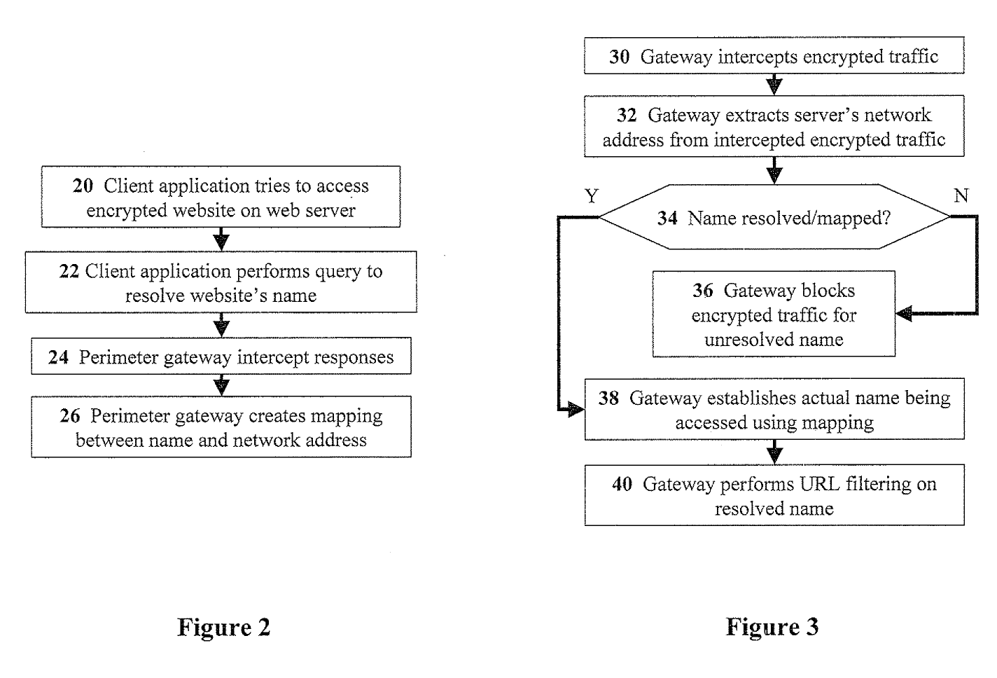

FIG. 2 is a simplified flowchart of the major operational steps for encrypted-traffic URL filtering using address-mapping interception during the mapping phase, according to preferred embodiments of the present invention. The process starts when a client application (e.g. browser), running from a client system, tries to access an encrypted website on a web server (Step 20). The client application performs a name-to-address query (e.g. DNS query) to resolve the website's name (e.g. domain name) (Step 22). A perimeter gateway intercepts the address-mapping (e.g. DNS) responses (Step 24), and creates a mapping between the name and one or more network addresses (Step 26). Establishing such a mapping requires a period of time during which encrypted traffic (e.g. SSL-encrypted HTTP traffic) is not rejected.

FIG. 3 is a simplified flowchart of the major operational steps for encrypted-traffic URL filtering using address-mapping interception during the policy-enforcement phase, according to preferred embodiments of the present invention. The perimeter gateway intercepts the encrypted traffic (Step 30), and extracts the server's network address from the packets of the encrypted traffic (Step 32). The perimeter gateway then determines whether the name has been resolved/mapped (Step 34).

If the name has not been resolved, the perimeter gateway blocks the encrypted traffic for the unresolved name (Step 36). If the name has been resolved, the perimeter gateway establishes the actual host name (e.g. domain name) being accessed by reversing the abovementioned mapping (Step 38), and performs URL filtering (e.g. redirecting) on the resolved name (Step 40). A user or system administrator can also be alerted about the blocked encrypted traffic.

It is noted that the relevant aspects of Steps 20-26 of FIG. 2 and Steps 30-40 of FIG. 3 can be performed by various modules (e.g. software, hardware, and firmware) residing in perimeter gateway 16 of FIG. 1. It is also noted that during initial deployment there is a stage in which the mappings remain cached on the client system. During this stage, new mappings can be established on the perimeter gateway 16, but no traffic filtering is performed.

Such a solution is a passive approach to handling encrypted traffic. The user is not aware of the inspection, nor does the inspection require any termination of the actual connection; whereas, all prior-art solutions are based on actively terminating SSL connections, and impersonating the server, or using a pre-configured shared secret (e.g. passive SSL decryption) between the accessed server and the gateway (e.g. private keys).

While the invention has been described with respect to a limited number of embodiments, it will be appreciated that many variations, modifications, and other applications of the invention may be made.

What is claimed is:

1. A method for encrypted-traffic URL (Uniform Resource Locator) filtering using address-mapping interception, the method comprising the steps of:
(a) providing a client system having a client application for accessing websites from web servers;
(b) upon said client application attempting to access an encrypted website, performing, by said client application, a name-to-address query to resolve a name of said encrypted website;
(c) intercepting, by a perimeter gateway, address-mapping responses;
(d) creating, by said perimeter gateway, a mapping between said name and at least one network address of said encrypted website;
(e) intercepting, by said perimeter gateway, incoming encrypted traffic;
(f) extracting, by said perimeter gateway, a server's network address from said incoming encrypted traffic;
(g) establishing, by said perimeter gateway, a resolved name being accessed using said mapping; and
(h) filtering, by said perimeter gateway, said resolved name.

2. The method of claim 1, wherein said client application is a browser application.

3. The method of claim 1, wherein said name-to-address query is a DNS (Domain Name System) query, wherein said address-mapping responses are DNS responses, wherein said name is a domain name, wherein said at least one network address is at least one IP (Internet Protocol)-address, and wherein said resolved name is a resolved domain name.

4. The method of claim 1, wherein said incoming encrypted traffic includes at least one traffic type from the group consisting of: SSL (Secure Sockets Layer)-encrypted traffic, Internet-Protocol-security (IPsec) traffic, secure-shell (SSH) traffic, transport-layer-security (TLS) traffic, and SSL-encrypted HTTP (Hyper-Text Transfer Protocol) traffic.

5. The method of claim 1, wherein said step of filtering includes redirecting said encrypted traffic.

6. The method of claim 1, the method further comprising the step of:
(i) blocking, by said perimeter gateway, all encrypted traffic for unresolved names.

7 The method of claim 1, the method further comprising the step of:
(i) alerting a user or a system administrator about said encrypted traffic.

8. A computer-readable storage medium having computer-readable code embodied on the computer-readable storage medium, the computer-readable code comprising:
(a) program code for providing a client system with a client application for accessing websites from web servers;
(b) program code for, upon said client application attempting to access an encrypted website, performing, by said client application, a name-to-address query to resolve a name of said encrypted website;
(c) program code for intercepting, by a perimeter gateway, address-mapping responses;
(d) program code for creating, by said perimeter gateway, a mapping between said name and at least one network address of said encrypted website;
(e) program code for intercepting, by said perimeter gateway, incoming encrypted traffic;
(f) program code for extracting, by said perimeter gateway, a server's network address from said incoming encrypted traffic;
(g) program code for establishing, by said perimeter gateway, a resolved name being accessed using said mapping; and
(h) program code for filtering, by said perimeter gateway, said resolved name.

9. The storage medium of claim 8, wherein said client application is a browser application.

10. The storage medium of claim 8, wherein said name-to-address query is a DNS (Domain Name System) query, wherein said address-mapping responses are DNS responses, wherein said name is a domain name, wherein said at least one network address is at least one IP (Internet Protocol)-address, and wherein said resolved name is a resolved domain name.

11. The storage medium of claim 8, wherein said incoming encrypted traffic includes at least one traffic type from the group consisting of: SSL (Secure Sockets Layer)-encrypted traffic, Internet-Protocol-security (IPsec) traffic, secure-shell (SSH) traffic, transport-layer-security (TLS) traffic, and SSL-encrypted HTTP (Hyper-Text Transfer Protocol) traffic.

12. The storage medium of claim 8, wherein said program code for filtering includes program code for redirecting said encrypted traffic

13. The storage medium of claim 8, the computer-readable code further comprising:
(i) program code for blocking, by said perimeter gateway, all encrypted traffic for unresolved names.

14. The storage medium of claim 8, the computer-readable code further comprising:
(i) program code for alerting a user or a system administrator about said encrypted traffic.

15. A perimeter gateway for encrypted-traffic URL (Uniform Resource Locator) filtering using address-mapping interception, the gateway comprising:
(a) a query module for performing, upon a client application of a client system attempting to access an encrypted website, a name-to-address query to resolve a name of an encrypted website on a web server;
(b) a response module for intercepting address-mapping responses;
(c) a mapping module for creating a mapping between said name and at least one network address of said encrypted website;
(d) an encrypted-traffic module for intercepting incoming encrypted traffic;
(e) an extraction module for extracting a server's network address from said incoming encrypted traffic;
(f) a resolving module for establishing a resolved name being accessed using said mapping; and
(g) a filtering module for filtering said resolved name.

16. The gateway of claim 15, wherein said client application is a browser application.

17. The gateway of claim 15, wherein said name-to-address query is a DNS (Domain Name System) query, wherein said address-mapping responses are DNS responses, wherein said name is a domain name, wherein said at least one network address is a at least one IP (Internet Protocol)-address, and wherein said resolved name is a resolved domain name.

18. The gateway of claim 15, wherein said incoming encrypted traffic includes at least one traffic type from the group consisting of: SSL (Secure Sockets Layer)-encrypted traffic, Internet-Protocol-security (IPsec) traffic, secure-shell (SSH) traffic, transport-layer-security (TLS) traffic, and SSL-encrypted HTTP (Hyper-Text Transfer Protocol) traffic.

19. The gateway of claim 15, wherein said filtering module is configured for redirecting said encrypted traffic.

20. The gateway of claim 15, the gateway further comprising:
(h) a blocking module for blocking all encrypted traffic for unresolved names.

21. The gateway of claim 15, the gateway further comprising:
(h) an alerting module for alerting a user or a system administrator about said encrypted traffic.
